(19) United States
(12) Patent Application Publication
(10) Pub. No.: US 2026/0081073 A1
(43) Pub. Date: Mar. 19, 2026

(54) HIGH-POWER AND HIGH ENERGY-DENSITY CAPACITOR WITH SCAVENGER

(71) Applicant: Weinberg Medical Physics, Inc., North Bethesda, MD (US)

(72) Inventor: Irving N. WEINBERG, Chevy Chase, MD (US)

(21) Appl. No.: 19/323,487

(22) Filed: Sep. 9, 2025

Related U.S. Application Data
(60) Provisional application No. 63/696,022, filed on Sep. 18, 2024.

(51) Int. Cl. H01G 4/06

(52) U.S. Cl. CPC H01G 4/06

(57) ABSTRACT

An apparatus and method of constructing high power density capacitors. The apparatus and method may include scavenging materials between and around high-permittivity dielectric sections. Scavenging materials are added to the capacitor to remove electrons or holes that can lead to breakdown, without substantially reducing capacitance.

### CROSS-REFERENCE AND PRIORITY CLAIM

This application claims priority to U.S. Provisional Patent Application Ser. No. 63/693,022 entitled “HIGH-POWER AND HIGH ENERGY-DENSITY CAPACITOR WITH SCAVENGER” filed Sep. 10, 2024, the entirety of which is incorporated by reference.

### FIELD

An apparatus and method of constructing high-power and high energy-density capacitors.

### BACKGROUND

The capacitance of a capacitor is proportional to the dielectric strength of the material used in the capacitor. In general, the maximum energy density of the capacitor is proportional to the capacitance times the square of the breakdown voltage of the capacitor. Placing insulating barriers within the capacitor can increase the breakdown voltage but has the deleterious effect of decreasing series capacitance, which reduces overall energy density.

### SUMMARY

Disclosed embodiments describe an apparatus and method of constructing high power density capacitors. The apparatus and method may include scavenging materials between and around high-permittivity dielectric sections. In the present disclosure, scavenging materials are added to the capacitor to remove electrons or holes that can lead to breakdown, without substantially reducing capacitance.

In accordance with the disclosed embodiments, a capacitor apparatus comprises:
at least one scavenger material, and at least one high-permittivity dielectric material, wherein the presence of the scavenger material increases the breakdown voltage of the capacitor by at least a factor of 5 without substantially reducing the capacitance.

In some embodiments, the high-permittivity dielectric material has a permittivity of more than 100.

In some embodiments, the high-permittivity dielectric material has a permittivity of more than 1,000.

In some embodiments, the high-permittivity dielectric material has a permittivity of more than 100,000.

In some embodiments, at least one of the scavenger materials is a scavenger of electrons.

In some embodiments, at least one of the scavenger materials is a scavenger of holes.

In some embodiments, at least one of the scavenger materials is initially a gas.

In some embodiments, a pressure within a capacitor enclosure at the time the capacitor is formed is higher than one bar.

In some embodiments, a pressure within a capacitor enclosure at the time the capacitor is formed is higher than 40 bars.

In some embodiments, at least one of the scavenger materials is initially a liquid.

In accordance with the disclosed embodiments, a method for manufacturing capacitors comprises combining scavenger material with high-permittivity dielectric material, and enclosing the combined scavenger material and high permittivity dielectric material, wherein the scavenger material increases the breakdown voltage of the capacitor by at least a factor of 5 without substantially reducing the capacitance.

In some embodiments, the high-permittivity dielectric material is exposed to the at least one of the scavenger materials prior to enclosure.

In some embodiments, the high-permittivity dielectric material is exposed to at least one of the scavenger materials at the time of enclosure.

In some embodiments, at least one of the high-permittivity dielectric materials has a permittivity of more than 100.

In some embodiments, at least one of the high-permittivity dielectric materials has a permittivity of more than 1,000.

In some embodiments, at least one of the high-permittivity dielectric materials has a permittivity of more than 100,000.

In some embodiments, at least one of the scavenger materials is a scavenger of electrons.

In some embodiments, at least one of the scavenger materials is a scavenger of holes.

In some embodiments, at least one of the scavenger materials is initially a liquid.

In some embodiments, at least one of the scavenger materials is initially a gas.

In some embodiments, the method further comprises introducing pressure within the enclosed capacitor so that the pressure is higher than one bar.

In some embodiments, the method further comprises introducing pressure

### BRIEF DESCRIPTION OF THE FIGURES

FIG. 1 shows an embodiment of the apparatus comprising a capacitor; and

FIG. 2 shows an embodiment of the process used to build the capacitor.

### DETAILED DESCRIPTION

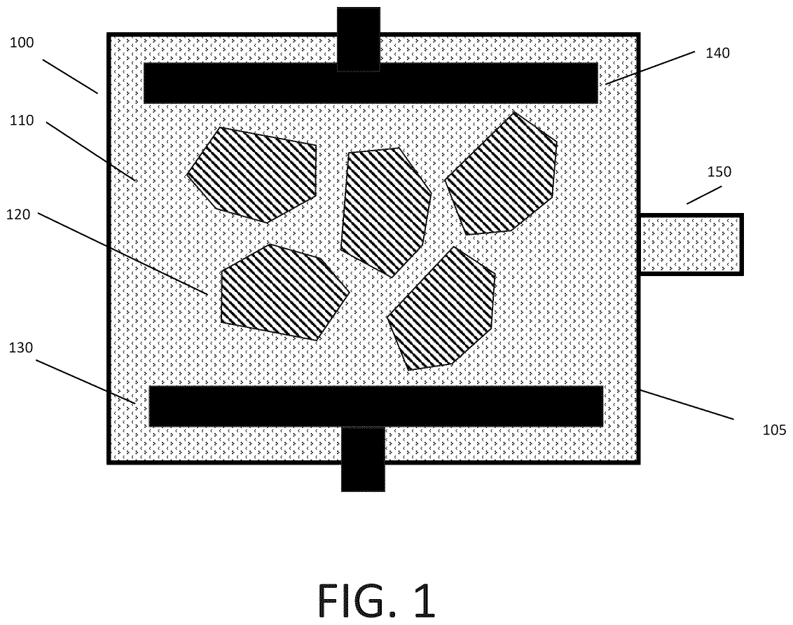

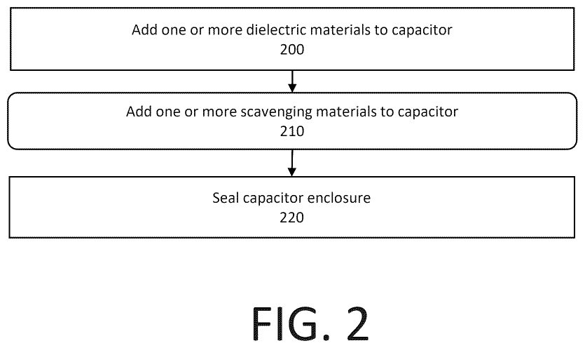

Disclosed embodiments describe an apparatus comprising a capacitor (FIG. 1) and method of assembling said capacitor (FIG. 2). The apparatus contains grains or other subunits of high-permittivity dielectric materials, which are surrounded by one or more scavenger materials.

As shown in FIG. 1, a capacitor enclosure 100 holds the inner contents of the capacitor. One or more scavenging materials 110 are among the inner contents of the capacitor 105. One or more high-permittivity dielectric materials 120 are among the inner contents of the capacitor 105. Electrodes 130 and 140 are used to make contact to the capacitor. Sealable connector 150 is used to fill the capacitor with scavenging material.

For purposes of this disclosure, the term “high-permittivity dielectric material” is used to designate a dielectric material with a permittivity greater than 70 (such as barium titanate), or a material with colossal permittivity (such as doped strontium titanate, with a permittivity reported to be over 100,000).

For the purposes of this disclosure, the terms “scavenger”, “scavenging materials, and “scavenging materials” are used to designate one or more materials that chemically reduce the ability of a species responsible for electrical breakdown in a capacitor. Such scavengers may be gaseous, liquid, or solid. If the species is an electron, then sulfur hexafluoride (“SF6”) may be considered as a scavenger, which removes electrons. Methanol is an example of a hole scavenger, which removes holes.

It is known that filling a hollow capacitor solely with a scavenger material can increase the breakdown voltage of the capacitor, as taught for example by H.-G. Latzel and K. Schon in the 1987 IEEE Transactions on Instrumentation and Measurement, entitled “Precise Capacitance Measurements of High-Voltage Compressed Gas Capacitors”.

Most insulators work by erecting barriers to primary electrons, thereby decreasing capacitance and therefore decreasing overall energy density. Electron-scavenging materials increase breakdown voltage by chemically reducing the ability of primary electrons to cause avalanches of additional electrons, as taught by A. Rein, A. Arnesen, and I. Johansen in the 1977 IEEE Transactions on Power Apparatus and Systems, entitled “A Statistical Approach to the Streamer Breakdown Criterion in SF6”.

The mechanism by which some materials exhibit colossal permittivity has been described as ionic separation during polarization, as taught in the 2017 Physical Review Materials by R. Federicci et al, entitled Tb₂Ti₂O5: Superionic conductor with colossal dielectric constant. In such a material, the species involved in voltage breakdown (e.g., electrons or holes) may be different from the species involved in attaining high permittivity (e.g., ions).

In the disclosed embodiments, the addition of gaseous or liquid or solid scavengers to high-permittivity dielectric materials within a capacitor results in high breakdown voltage. As discussed above, increasing the breakdown voltage increases the energy density of the capacitor. Examples of high breakdown voltages include 100 volts per micron (as in polyimide films) or 1000 volts per micron (as in diamond).

The contemplated pressures (or partial pressures) within the presently described capacitor during the manufacturing process may be 1 bar to 40 bars, or higher, motivated by the fact that the quenching capability of scavengers generally increases with pressure (as discussed by Rein et al). It is understood that some of the scavenging material remains in the capacitor after the manufacturing process.

In the disclosed embodiments, the increase in breakdown voltage is not accomplished primarily by introducing insulating materials between subunits of the dielectric materials (which would decrease overall capacitance) but by introducing scavenging species responsible for improving breakdown performance. For the purposes of this disclosure, the overall capacitance obtained after introducing or pressurizing the one or more scavenging materials into the capacitor is contemplated to be no less than 90% of the capacitance that would have resulted if the scavenging materials had not been introduced. For purposes of this disclosure, a substantial reduction in capacitance would be greater than 10% reduction of the capacitance that would have resulted if the scavenging materials had not been introduced. For the purposes of this disclosure, the breakdown voltage obtained after introducing or pressurizing the one or more scavenging materials into the capacitor is contemplated to be at least five times higher than the breakdown voltage that would have resulted if the scavenging materials had not been introduced.

In a method of manufacturing a high-power and high-density capacitor, one or more high-permittivity dielectric materials is introduced within the capacitor enclosure 200. For the purposes of this disclosure, high-permittivity may be defined as over 100, or over 1000 or over 100,000. One or more scavenging materials is introduced within the capacitor enclosure 210. Finally, the enclosure is sealed 220. In some embodiments, the high-permittivity dielectric material may be impregnated with the scavenging material prior to being sealed in the capacitor. In some embodiments, the enclosure is pressurized to between 1 bar to 40 bars, or higher to increase the quenching capabilities of the scavenging material. It is understood that the scavenger may change from its initial state in the course of the manufacturing process. For example, the scavenger material may change from gas to liquid or to solid due to pressure or temperature controlled in the manufacturing environment. In some embodiment two or more high-permittivity dielectric materials are introduced within the capacitor enclosure. It is understood that two or more different scavenging materials may be introduced to the high-permittivity dielectric material, and that the two or more scavenging materials may all be scavengers of holes, all be scavengers of electrons, or may be a combination of hole and electron scavenger materials.

While certain illustrative embodiments have been described, it is evident that many alternatives, modifications, permutations and variations will become apparent to those skilled in the art in light of the foregoing description. Accordingly, the various embodiments of, as set forth above, are intended to be illustrative, not limiting. Various changes may be made without departing from the spirit and scope of the invention.

1. A capacitor apparatus comprising:
at least one scavenger material, and
at least one high-permittivity dielectric material, wherein the presence of the scavenger material increases the breakdown voltage of the capacitor by at least a factor of 5 without substantially reducing the capacitance.

2. The apparatus of claim 1, wherein the high-permittivity dielectric material has a permittivity of more than 100.

3. The apparatus of claim 1, wherein the high-permittivity dielectric material has a permittivity of more than 1,000.

4. The apparatus of claim 1, wherein the high-permittivity dielectric material has a permittivity of more than 100,000.

5. The apparatus of claim 1, wherein at least one of the scavenger materials is a scavenger of electrons.

6. The apparatus of claim 1, wherein at least one of the scavenger materials is a scavenger of holes.

7. The apparatus of claim 1, wherein at least one of the scavenger materials is initially a gas.

8. The apparatus of claim 6, wherein a pressure within a capacitor enclosure at the time the capacitor is formed is higher than one bar.

9. The apparatus of claim 1, wherein at least one of the scavenger materials is initially a liquid.

10. A method for manufacturing capacitors comprising:
combining scavenger material with high-permittivity dielectric material, and enclosing the combined scavenger material and high permittivity dielectric material, wherein the scavenger material increases the breakdown voltage of the capacitor by at least a factor of 5 without substantially reducing the capacitance.

11. The method of claim 10, wherein the high-permittivity dielectric material is exposed to the at least one of the scavenger materials prior to enclosure.

12. The method of claim 10, wherein the high-permittivity dielectric material is exposed to at least one of the scavenger materials at the time of enclosure.

13. The method of claim 10, wherein at least one of the high-permittivity dielectric materials has a permittivity of more than 100.

14. The method of claim 10, wherein at least one of the high-permittivity dielectric materials has a permittivity of more than 1,000.

15. The method of claim 10, wherein at least one of the high-permittivity dielectric materials has a permittivity of more than 100,000.

16. The method of claim 10, wherein at least one of the scavenger materials is a scavenger of electrons.

17. The method of claim 10, wherein at least one of the scavenger materials is a scavenger of holes.

18. The method of claim 10, wherein at least one of the scavenger materials is initially a liquid.

19. The method of claim 10, wherein at least one of the scavenger materials is initially a gas.

20. The method of claim 10, further comprising introducing pressure within the enclosed capacitor so that the pressure is higher than one bar.
